(19) United States
(12) Patent Application Publication
(10) Pub. No.: US 2005/0267234 A1
(43) Pub. Date: Dec. 1, 2005

(54) Resistant printing ink system

(75) Inventor: Terry Duane Kern, Alger, OH (US)

Correspondence Address: INTERNATIONAL PAPER COMPANY, 6285 TRI-RIDGE BOULEVARD, LOVELAND, OH, 45140, US

(73) Assignee: International Paper Company

(21) Appl. No.: 11/130,721

(22) Filed: May 17, 2005

Related U.S. Application Data
(60) Provisional application No. 60/573,029, filed on May 19, 2004.

(51) Int. Cl. C03C 17/00

(52) U.S. Cl. 523/160

(57) ABSTRACT

A water-based acrylic ink system utilizes acrylic color dispersions produces resistant printing inks films that do not bleed when contacting cleaning and disinfectant chemicals. The resistant printing ink system includes an alkali resistant styrene-acrylic hybrid copolymer and an aqueous acrylic dispersion system supporting the alkali resistant styrene-acrylic hybrid copolymer. An amine dispersant such as morpholine can be added to the styrene-acrylic hybrid copolymer before the dispersion is added.

### CROSS-REFERENCE TO RELATED APPLICATION

This application claims the benefit under 35 U.S.C. § 119 (e), of copending U.S. Provisional Application No. 60/573,029, filed May 19, 2004.

### BACKGROUND OF THE INVENTION

1. Field of the Invention

The invention relates to resistant, water-based acrylic inks and methods of making the ink systems.

2. Description of the Related Art

Commercial paper cups, such as those used in the fast-food industry, include a polyethylene coating. Prior-art inks bleed on cups with a polyethylene coating, especially, when contacted with cleaners and disinfectants.

In prior-art resistant ink systems, the pigment dispersion portion of the printing is dispersed in the same resin as the finished ink system. However, dispersing pigments in a resin system used for resistant inks generally produces unstable dispersions with limited shelf lives.

As a result, the prior art requires a separate, additional inventory of short-lived resistant inks. The short-lived nature of the inks requires suppliers to keep small inventories of limited numbers of colors of inks to prevent the expiration of inventory.

Another problem with most prior-art systems is that, when most reactive monomers were used to produce inks that had resistant properties, the inks would dry on the printing plate and the anilox.

Another problem with using reactive monomers in ink is that, reactive monomers yield inks with limited resolution.

### SUMMARY OF THE INVENTION

It is accordingly an object of the invention to provide a water-based acrylic ink system utilizing conventional acrylic pigmented dispersions that overcomes the above-mentioned disadvantages of the heretofore-known devices and methods of this general type by producing resistant printing inks films that do not bleed when contacting cleaning and disinfectant chemicals.

With the foregoing and other objects in view there is provided, in accordance with the invention, a resistant printing ink system that includes an alkali resistant styrene-acrylic hybrid copolymer and an aqueous pigmented dispersion system supporting the alkali resistant styrene-acrylic hybrid copolymer.

Alkali resistant styrene-acrylic hybrid copolymers are known and commercially available. Hybrid copolymers result, for example from the graft-copolymerization of styrene monomer in the presence of an acrylic polymer emulsion, whereby a sequence of styrene monomer units becomes attached to a branch point in the chain of an acrylic polymer.

In the symbolic representation below, at least one acrylic monomer, such as ethyl acrylate, methyl methacrylate, isobutyl acrylate, acrylic acid, or 2-ethylhexyl methacrylate is symbolized by A, and at least one styrene monomer (i.e. phenylethene and substituted derivatives such s m-methylstyrene, p-methylstyrene , ethylstyrene, and mixtures thereof) is symbolized by S. Accordingly, a hybrid graft styrene acrylic copolymer can be symbolized by

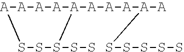

Other hybrid styrene acrylic copolymers used according to the invention include alternating hybrid copolymers, which can be symbolized by
S-A-S-A-S-A-S-A-S-A,
random copolymers which can be symbolized by
S-S-A-A-A-A-S-A-A-A-S-S-S-S-S-A-A-S-S-S-A,
and block copolymers, which can be symbolized by
S-S-S-S-S-S-A-A-A-A-A-A-A-A-A-S-S-S-S-SS

In accordance with a further object of the invention, the resistant printing ink system can include any or all of the following additional components:
an amine dispersant to assist in dispersing the hybrid copolymer, and for adjusting a pH in a range from 8.5 to 9.5, such as morpholine;
a siloxane glycol copolymer;
a resolubility aid;
a propylene glycol compound;
an acrylic water based color dispersion;
an oxidized polyethylene wax;
an emulsifiable polydimethylsiloxane;
an organosiloxane polymer/siloxane glycol copolymer; and
a diol ether.

With the objects of the invention in view, there is also provided a method for preparing a resistant printing ink system. The first step of the method includes providing an alkali resistant styrene-acrylic hybrid copolymer. The next step is adjusting a pH in a range from 8.5 to 9.5 by adding an amine dispersant. The next step is adding an aqueous pigmented dispersion system supporting the alkali resistant styrene-acrylic hybrid copolymer.

With the objects of the invention in view, there is also provided a method for preparing a resistant printing ink system, that includes the following sequence of steps:
providing an alkali resistant styrene-acrylic hybrid copolymer;
adding a siloxane glycol copolymer;
adjusting a pH in a range from 8.5 to 9.5 by adding an amine dispersant;
adding a resolubility aid;
adding propylene glycol;
adding an acrylic water based pigmented dispersion system supporting said alkali resistant styrene-acrylic hybrid copolymer;
adding an oxidized polyethylene wax capable of dispersion in water;
adding an emulsifiable polydimethylsiloxane;
adding an organosiloxane polymer/siloxane glycol copolymer; and
adding a diol ether.

In accordance with a further object of the invention, certain reactive monomer combinations that produce very resistant films when subjected to temperatures above 110° F. have been applied to the field of inks. The reactive monomers cure further upon aging.

In accordance with a further object of the invention, a printing ink is provided that can be used with conventional pigmented dispersion systems. By using conventional dispersion systems, inventories are not increased. In addition, all pigment types that are normally available can be used in the resistant inks according to the invention.

In accordance with a further object of the invention, an ink is provided that can be stored for at least eleven months without degradation relating to viscosity or stability.

Other features which are considered as characteristic for the invention are set forth in the appended claims.

Although the invention is illustrated and described herein as embodied in a resistant printing ink system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying example.

### DESCRIPTION OF THE PREFERRED EMBODIMENTS

Referring now to the examples, a chemical composition and method of manufacturing is described.

The following example is an alkali resistant water-based ink formulation. The order of addition is an important part of creating a stable printing ink system.

| ORDER OF | WEIGHT | |
|---|---|---|
| ADDITION | PERCENT | INGREDIENT |
| 1 | 47.79 | Self-cross-linking styrene-acrylic hybrid |
| | | copolymer emulsion |
| 2 | 0.25 | Defoamer (Siloxane glycol Copolymer) |
| 3 | 0.84 | Amine (Morpholine) |
| 4 | 1.20 | Resoluability aid (Blend of anionic/nonionic |
| | | surfactants) |
| 5 | 4.00 | Coalescent (1,2-dihydroxypropane) |
| 6 | 7.10 | Colorant (Aqueous/acrylic dispersion of |
| | | CI Pigment Red R-238) |
| 7 | 6.64 | Colorant (Aqueous/acrylic dispersion of |
| | | CI Pigment Yellow Y-14) |
| 8 | 25.93 | Colorant (Aqueous/acrylic dispersion of |
| | | CI Pigment Red R-2) |
| 9 | 1.30 | Leveling agent (Polyether siloxane |
| | | copolymer |
| 10 | 4.00 | Micronized wax (Dispersion of oxidized |
| | | polyethylene wax) |
| 11 | 1.30 | Slip Additive |
| | | (Octamethycyclotetrasiloxane) |
| 12 | 0.25 | Defoamer (Organosiloxane polymer) |
| 13 | 3.00 | Coalescent (Diethylene glycol |
| | | monobutyl ether) |

The first component to be added is the styrene-acrylic hybrid copolymer such as the one sold under the trade name ARMOREZ® CR-2912 by MeadWestvaco. The supplier has described the product as a hybrid result of epoxy/acrylic technology, in particular an epoxy ester grafted to a styrene-acrylic copolymer, and referred to the website http://www.meadwestvaco.com/waterbased.nsf/vDES/9BEE5FA9A857B9 A885256E4A00503F32. The copolymer is resistant to alkalis such as cleaners and disinfectants. However, without more, the copolymer is not stabile in an aqueous dispersion and will agglomerate.

The second component to be added is a siloxane glycol copolymer such as that sold under the trade name DEE FO PI 35 by Ultra Additives.

The third component is an amine dispersant such as that sold under the name MORPHOLINE by Ashland Chemical. Morpholine is used here to adjust the pH in a range between 8.5 and 9.5, and as an aqueous dispersant that can support the stability of the CR-2912 resin dispersion. Morpholine can contain minor amounts of other amines, such as di- or trialkylamines (e.g. diethylamine, tripropylamine), di- or trialkanolamines (e.g. triethanolamine), N,N-diethylethanolamine, polyethylene imines (e.g. Corcat P-600 (MW=600,000 and Coreat P-12 (MW=12,000). Morpholine is commercially available from Virginia Chemical, Portsmouth, Va. Morpholine is a nitrogen oxygen heterocyclic compound, six membered oxygen nitrogen heterocyclic compound, tetrahydro oxazine, cyclic secondary amine, cyclic amino ether.

The fourth component to be added is a resolubility aid such as one sold under the trade name WD-28 by Elementis Inc. WD-28 is a blend of anionic and nonionic surfactants. The resolubility aid helps to redissolve any components of the ink that might have separated on the rollers during flexographic printing.

The fifth ingredient is a propylene glycol compound. A preferred propylene glycol compound is propylene glycol itself, available from Ashland Chemical. Useful propylene glycol compounds include glycols and polyalkylene derivatives thereof. An example includes propylene glycol-industrial 1,2-propanediol. The propylene glycol compound acts as a coalescing agent that helps to form a continuous film of the ink on the roller of the printing press.

The sixth component is an acrylic water based pigment dispersion such as one sold under the trade name RS 9238 by Heubach.

The seventh component is a Y-14 acrylic water-based dispersion such as the one sold under the trade name PYS-2031 G.S. Yellow by International Paper.

The eighth ingredient is an R-2 acrylic water based dispersion such as the one sold under the trade name RP-425 by Campbell Color.

The ninth ingredient is a polyether modified polysiloxane such as the one sold under the trade name TEGO-WET 251 by Goldschmidt.

The tenth component to be added is an oxidized polyethylene wax, such as the one sold in dispersion form under the trade name MICROSPERSION 235 by Micro Powders.

The eleventh component to be added is a polydimethylsiloxane such as the one sold as an emulsion under the trade name HV 490 SILICONE by Dow Corning.

The twelfth component is an organosiloxane polymer/siloxane glycol copolymer such as the one sold under the trade name FOAMTROL XRM-4693A by Ultra Additives.

The last component is diol ether, preferably a diol ether having at least one ether group and an alcoholic hydroxyl group. A particularly preferred diol ether is sold under the trade name GLYCOL ETHER DB by Superior Solvents & Chemicals. Another possibility is 2-(2-butoxyethoxy)ethanol. Other examples of suitable diol ethers include one or more of the following low molecular weight diol ethers known in the art, for example, ethylene-glycol monomethyl ether, ethylene-glycol monoethyl ether, diethylene-glycol monomethyl ether, diethylene-glycol monobutyl ether, 1-butoxyethoxy-2-propanol, diethylene-glycol monoethyl ether, ethylene-glycol monobutyl ether, ethylene-glycol monohexyl ether, phenyl glycol ethers, butoxytriglycol, methoxytriglycol, and ethoxytriglycol. Polyoxyethylene glycols such as ethoxytriglycol and methoxytriglycol are preferred. Propylene glycol phenyl is another possibility. Other possible glycol ethers include ethylene glycol mono (alkyl having 4 to 8 carbons) ether, triethylene glycol mono (alkyl having 4 to 8 carbons) ether, propylene glycol mono (alkyl having 3 to 6 carbons) ether, or dipropylene glycol mono (alkyl having 3 to 6 carbons) ether.

1. A resistant printing ink system, comprising:
an alkali resistant styrene-acrylic hybrid copolymer; and
an aqueous acrylic dispersion system supporting said alkali resistant styrene-acrylic hybrid copolymer.

2. The resistant printing ink system according to claim 1, further comprising an amine dispersant, and having a pH in a range from 8.5 to 9.5.

3. The resistant printing ink system according to claim 2, wherein said amine dispersant is morpholine.

4. The resistant printing ink system according to claim 1, further comprising a siloxane glycol copolymer.

5. The resistant printing ink system according to claim 1, further comprising a resolubility aid.

6. The resistant printing ink system according to claim 1, further comprising a propylene glycol compound.

7. The resistant printing ink system according to claim 1, further comprising an acrylic water based dispersion.

8. The resistant printing ink system according to claim 1, further comprising an emulsifiable polyether modified polysiloxane.

9. The resistant printing ink system according to claim 1, further comprising an oxidized polyethylene wax.

10. The resistant printing ink system according to claim 1, further comprising an emulsifiable polydimethylsiloxane.

11. The resistant printing ink system according to claim 1, further comprising an organosiloxane polymer/siloxane glycol copolymer.

12. The resistant printing ink system according to claim 1, further comprising a diol ether.

13. The resistant printing ink system according to claim 1, wherein said diol ether is selected form the group consisting of 2-(2-butoxyethoxy)ethanol, ethylene-glycol monomethyl ether, ethylene-glycol monoethyl ether, diethylene-glycol monomethyl ether, diethylene-glycol monobutyl ether, 1-butoxyethoxy-2-propanol, diethylene-glycol monoethyl ether, ethylene-glycol monobutyl ether, ethylene-glycol monohexyl ether, phenyl glycol ethers, butoxytriglycol, methoxytriglycol, ethoxytriglycol, polyoxyethylene glycol, ethoxytriglycol, methoxytriglycol, propylene glycol phenyl, ethylene glycol mono (alkyl having 4 to 8 carbons) ether, triethylene glycol mono (alkyl having 4 to 8 carbons) ether, propylene glycol mono (alkyl having 3 to 6 carbons) ether, and dipropylene glycol mono (alkyl having 3 to 6 carbons) ether.

14. A resistant printing ink system, comprising:
an alkali resistant styrene-acrylic hybrid copolymer;
an aqueous acrylic dispersion system supporting said alkali resistant styrene-acrylic hybrid copolymer;
morpholine adjusting a pH in a range from 8.5 to 9.5;
a siloxane glycol copolymer;
a resoluability aid;
a propylene glycol;
an polyether modified polysiloxane;
an oxidized polyethylene wax dispersion;
an emulsion of polydimethylsiloxane;
an organosiloxane polymer/siloxane glycol copolymer;
a diol ether selected form the group consisting of 2-(2-butoxyethoxy)ethanol, ethylene-glycol monomethyl ether, ethylene-glycol monoethyl ether, diethylene-glycol monomethyl ether, diethylene-glycol monobutyl ether, 1-butoxyethoxy-2-propanol, diethylene-glycol monoethyl ether, ethylene-glycol monobutyl ether, ethylene-glycol monohexyl ether, phenyl glycol ethers, butoxytriglycol, methoxytriglycol, ethoxytriglycol, polyoxyethylene glycol, ethoxytriglycol, methoxytriglycol, propylene glycol phenyl, ethylene glycol mono (alkyl having 4 to 8 carbons) ether, triethylene glycol mono (alkyl having 4 to 8 carbons) ether, propylene glycol mono (alkyl having 3 to 6 carbons) ether, and dipropylene glycol mono( alkyl having 3 to 6 carbons) ether.

15. A method for preparing a resistant printing ink system, which comprises the sequence:
adding an alkali resistant styrene-acrylic hybrid copolymer;
adjusting a pH in a range from 8.5 to 9.5 by adding an amine dispersant; and
adding an aqueous dispersion system supporting said alkali resistant styrene-acrylic hybrid copolymer.

16. A method for preparing a resistant printing ink system, which comprises the sequence:
adding an alkali resistant styrene-acrylic hybrid copolymer;
adding a siloxane glycol copolymer;
adjusting a pH in a range from 8.5 to 9.5 by adding an amine dispersant;
adding a resoluability aid;
adding propylene glycol;
adding an acrylic water based dispersion system supporting
said alkali resistant styrene-acrylic hybrid copolymer; adding an polyether modified polysiloxane;
adding an oxidized polyethylene wax dispersion;
adding an emulsion of polydimethylsiloxane;
adding an organosiloxane polymer/siloxane glycol copolymer; and
adding a diol ether.
